(19) United States
(12) Patent Application Publication
(10) Pub. No.: US 2010/0126029 A1
(43) Pub. Date: May 27, 2010

(54) Reconfigurable portable powered tool and method of reconfiguring such a tool

(76) Inventor: Brent Peterson, Buffalo Grove, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/315,023

(22) Filed: Nov. 25, 2008

(51) Int. Cl. A01G 3/00; A01D 34/00

(52) U.S. Cl. 30/519; 30/275.4; 30/122; 29/401.1

(57) ABSTRACT

A portable powered tool has a frame, a working component on the frame for performing an operation, a drive on the frame for operating the working component, a shaft having a first output portion that is driven by the drive around a first axis to thereby cause operation of the working component, and a transmission assembly operatively connected to the first output portion of the shaft to transmit a drive force from the first output portion to the working component to thereby cause operation of the working component.

### BACKGROUND OF THE INVENTION

1. Field of the Invention

This invention relates to portable, powered tools and, more particularly, to tools having a working component driven by a shaft.

2. Background Art

Portable, powered tools are used in many different industries and for many different applications by both professionals and non-professionals. Many different types of such tools are utilized in the landscaping industry. In this industry, the working component may be: a rotary, flexible line trimmer; a cutter utilizing an endless moving chain; a cutter with relatively movable blades, etc.

In the landscaping industry, these types of tools are commonly made with elongate housings which permit an extended reach and controlled placement of the working component at an operating site. For example, working components that utilize reciprocating cutting blades to trim hedges, and the like, are often made with elongate housings to allow cutting at relatively high elevations with the user remaining safely on the ground. This obviates the need for lifts and ladders upon which a user might be precariously situated.

Tools such as this are commonly made with an elongate housing having a proximal end and a distal end, with the working component located at the latter. The user lifts and repositions the tool by controllably manipulating the proximal end of the housing. A drive, also at the proximal end of the housing, transmits an operating force to the working component through a shaft within the housing.

In designing tools of this type, one contends with a number of often competing objectives. First of all, it is desirable to extend the reach of the tool as much as possible without compromising the strength of the tool or making it difficult to control for a user. At the same time, consideration must be given to making the tool with a configuration that is practical for transportation from site to site, as may be carried out by a landscaping crew multiple times in any given day. It is known to make the housings extendable in nature, whereby the overall length can be extended on a job and reduced for transportation. This is commonly accomplished by providing telescoping housing and shaft lengths.

Even if the above type of structure is used to compact the tool for storage and transportation, it inherently has a long profile that is even more significant in the event that a working component itself has a significant length. For example, hedge trimmers utilizing reciprocating blades often have a lengthwise extent that may be on the order of one foot or greater. With the housing reconfigured for storage and transportation, the working component projects significantly beyond the length thereof.

Aside from the fact that the working component adds length, it also is prone to being damaged since it remains fully exposed with the unit in a storage/transportation configuration. This is particularly a problem in the landscaping environment wherein the tool may be placed in an unprotected state in a truck or upon a trailer where it may be intermixed with other equipment or materials.

Another problem with this type of tool is that it is normally configured to be operated primarily in a single orientation. That is, gripping components and handles are generally arranged to be held in a particular fashion in which the unit has the same orientation. Often, field conditions will require that a user reorient the working component, potentially into positions that were not contemplated by its design. Thus, a user may be required to improvise and potentially awkwardly support the tool during all or part of a particular operation. Extended use of a tool in an unintended orientation may cause user fatigue, and in a worst case an injury.

Alternatively, some tools of this type are made with handles and gripping components that can be unbolted and repositioned relative to the frame. However, this generally is difficult and time consuming enough that it will not be carried out by a user on a work site. Additionally, this operation generally requires specific tools which may not be kept on hand.

The industry continues to seek out designs that overcome the above problems and address the above objectives.

### SUMMARY OF THE INVENTION

In one form, a portable powered tool has a frame, a working component on the frame for performing an operation, a drive on the frame for operating the working component, a shaft having a first output portion that is driven by the drive around a first axis to thereby cause operation of the working component, and a transmission assembly operatively connected to the first output portion of the shaft to transmit a drive force from the first output portion to the working component to thereby cause operation of the working component.

In one form, the transmission assembly has a second output portion that is driven around a second axis by the drive through the first output portion.

In one form, the transmission assembly is configured to allow an angular relationship between the first and second axes to be selectively varied.

In one form, the transmission assembly has first and second housing parts that are movable guidingly relative to each other around a third axis to thereby change the angular relationship between the first and second axes. The first housing part has a first connection that attaches to the frame. The second housing part is operatively connected to the working component.

In one form, the transmission assembly has a shaft element that connects to the first and second housing parts and at least one of the first and second housing parts is guided by the shaft element around the third axis relative to the other of the first and second housing parts to thereby change the angular relationship between the first and second axes.

In one form, the second housing part has a second connector that attaches to the working component.

In one form, at least one of: a) the first connector is movable around the first axis relative to the frame to thereby change an angular orientation of the transmission assembly relative to the frame; and b) the second connector is movable around the second axis relative to the working component to thereby change an angular orientation of the transmission assembly relative to the working component.

In one form, at least one of: a) the first connector can be fixed relative to the frame with the transmission assembly in different angular orientations relative to the frame; and b) the second connector can be fixed relative to the working component with the transmission assembly in different angular orientations relative to the working component.

In one form, the transmission assembly has a two-sided center gear that is guided by the shaft element in movement around the third axis. The center gear transmits a drive force from the first output portion to the second output portion.

In one form, the two-sided center gear has a first gear and the first output portion has a first bevel gear that is in mesh with the first gear.

In one form, the two-sided center gear has a second gear and the working component has a second bevel gear that is in mesh with the second gear on the center gear at the second output portion of the transmission assembly.

In one form, the transmission assembly is a self-contained unit that can be separated from each of the working component and the frame.

In one form, the tool further has a locking assembly with a first locking component on the first housing part and a second locking component on the second housing part. The first and second locking components are configured to allow the first and second housing parts to be releasably maintained in a plurality of different relative portions corresponding to different angular relationships between the first and second axes.

In one form, one of the first and second locking components is in the form of a pin and the other of the first and second locking component consists of at least one member with a plurality of apertures to receive the pin with the first and second housing parts in different relative positions.

In one form, there are components cooperating between at least one of: a) the first connector and frame; and b) the second connector and working component to allow selection of a predetermined angular orientation between the at least one of: a) the first connector and frame; and b) the second connector and working component.

In one form, there is a clamp mechanism for releasably maintaining a predetermined angular orientation between the at least one of: a) the first connector and frame; and b) the second connector and working component.

In one form, the frame is in the form of a tubular element with an elongate shape having a length extending along the first axis. The shaft resides within the tubular element.

In one form, the working component is one of: a) a flexible line trimmer; b) a cutter with a cutting chain that moves in an endless path; and c) a cutter with at least one movable cutting blade.

The invention is further directed to a method of reconfiguring a portable powered tool including the steps of: a) providing a portable powered tool having: i) a frame; ii) a working component on the frame for performing an operation; iii) a drive on the frame for operating the working component; and iv) a shaft having an output portion that is driven by the drive around a first axis to thereby drive an input portion on the working component around a second axis to thereby cause operation of the working component; b) providing a transmission assembly with an input portion that is movable around one axis and an output portion that is caused by movement of the input portion of the transmission assembly around the one axis to move around another axis, the another axis having an angular relationship with the one axis that can be changed by reconfiguring the transmission assembly; c) separating the working component from the frame; and d) operatively connecting the transmission assembly to the working component and frame so that: i) the output portion on the frame is operatively engaged with the input portion of the transmission assembly; and ii) the output portion of the transmission assembly is operatively engaged with the input portion of the working component so that a force from the drive is transmitted through the transmission assembly to the working component for operation thereof.

In one form, the step of operatively connecting the transmission involves relatively moving the transmission assembly and frame along the first axis to thereby operatively engage the output portion on the frame with the input portion on the transmission assembly.

The method may include the step of relatively repositioning the working component and transmission assembly around the another axis.

The method may further include the step of selectively fixing the angular relationship of the one and another axes in any of a plurality of different angular relationships.

### BRIEF DESCRIPTION OF THE DRAWINGS

FIG. 1 is a schematic representation of a portable powered tool, of a type into which the present invention can be incorporated;

FIG. 2 is a schematic representation of a portable powered tool, as in FIG. 1, and incorporating a transmission assembly, according to the present invention;

FIG. 3 is a fragmentary, perspective view of one specific, exemplary form of portable powered tool, corresponding to that shown schematically in FIG. 2;

FIG. 4 is an enlarged, partially schematic, cross-sectional view of the transmission assembly in FIG. 3, in relationship to a portion of a frame and a working component, attached to separate housing parts thereon;

FIG. 5 is an enlarged, fragmentary, partially broken away, perspective view of the working component on the tool in FIG. 3;

FIG. 6 is an enlarged, fragmentary, perspective view of the transmission assembly, showing portions of the components to which it connects, from the same perspective as in FIG. 3;

FIG. 7 is an enlarged, perspective view of the inventive transmission assembly;

FIG. 8 is an enlarged, fragmentary view of a portion of the transmission assembly showing a locking assembly for housing parts thereon;

FIG. 9 is an enlarged, fragmentary, partially schematic representation of a portion of the locking assembly in FIG. 8;

FIG. 10 is a plan view of the inventive tool with the working component thereon in two different orientations relative to the frame, one of which represents a stored state;

FIG. 11 is an end view of the working component on the inventive tool in different orientations relative to the housing part upon which it is mounted;

FIG. 12 is a view as in FIG. 10 wherein the working component is placed in a stored state that is an alternative to that shown in FIG. 10;

FIG. 13 is a schematic representation of a clamp arrangement for locking housing parts relative to each other as an alternative to the locking assembly structure shown in FIG. 9; and

FIG. 14 is a schematic representation of a method of reconfiguring a portable power tool, according to the present invention.

### DETAILED DESCRIPTION OF THE PREFERRED EMBODIMENT

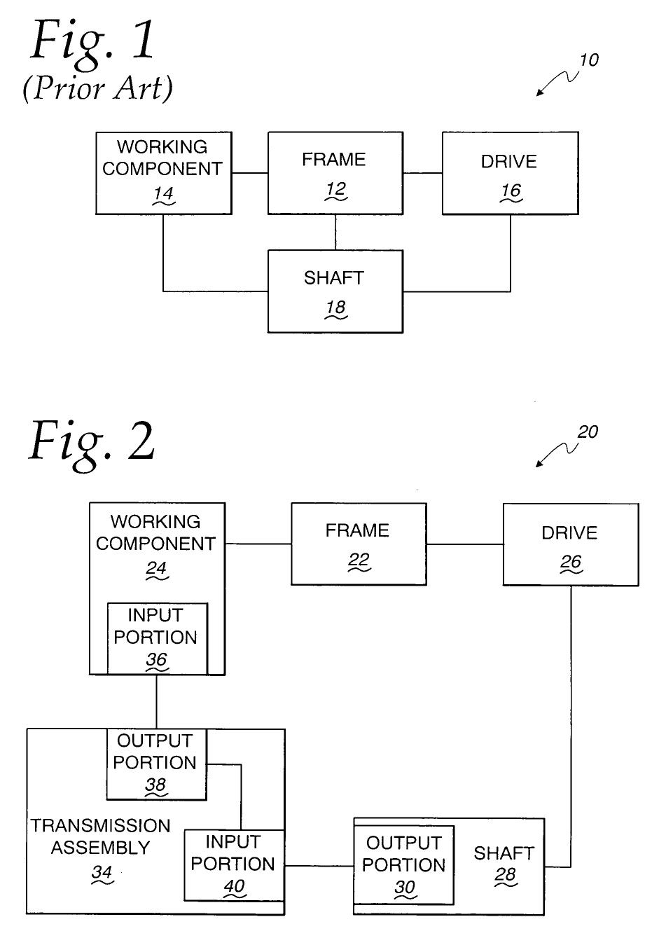

In FIG. 1, a schematic representation of a conventional, portable powered tool, into which the present invention can be incorporated, as shown at 10. The tool 10 consists of a frame 12 upon which a working component 14 is provided for performing an operation. A drive 16 is provided on the frame 12 for operating the working component 14 through a shaft 18. An exemplary form of the tool 10 is shown in U.S. Pat. No. 5,013,282. With this configuration, the working component 14 has a fixed relationship to the frame 12. Consequently, the design is such that it is contemplated the user will support and operate the tool in a predetermined orientation. At the same time, the fixed configuration for the tool does not permit it to be compacted appreciably for transportation and storage.

A schematic representation of a portable powered tool, according to the present invention, is shown in FIG. 2 at 20. The tool 20 has an arrangement of components that is similar to that for the tool 10 in FIG. 1. That is, the tool 20 has a frame 22 upon which a working component 24 is provided for performing an operation. A drive 26 is provided on the frame 22 for operating the working component 24. The drive 26 cooperates with a shaft 28 that has an output portion 30 that is driven by the drive 26 around a first axis, to thereby cause operation of the working component 24.

A transmission assembly 34 is operatively connected to the output portion 30 of the shaft 28 to transmit a drive force from the output portion 30 to an input portion 36 on the working component 24, to thereby cause operation of the working component 24. The transmission assembly 34 has an output portion 38 that is driven around a second axis by the drive 26. To effect this force transmission, the output portion 30 on the shaft 28 drives an input portion 40 on the transmission assembly 34. The input portion 40 on the transmission assembly 34 is driven around the first axis, around which the output portion 30 is likewise driven. Similarly, the input portion 36 on the working component 24 is driven around the same second axis as is the output portion 38 on the transmission assembly 34. The transmission assembly 34 is configured to allow an angular relationship between the first and second axes to be selectively varied.

The components in FIG. 2 are shown in schematic form since the invention contemplates virtually an unlimited number of different configurations for each such component. For example, the frame 22 may be an element with a straight, elongate shape, or may be otherwise configured over part or all of its extent. For example it might be curved, angled, etc., over part or all of its lengthwise extent.

The working component 24 may be any type of device that performs an operation on an object against which it is placed. As examples, the working component may be one that incorporates: a) a rotary, flexible trimmer line, as shown in U.S. Pat. No. 4,300,336; b) an endless cutting chain, as shown in U.S. Pat. No. 5,013,282; or c) a trimmer with at least one moving/reciprocating cutting blade, as shown in U.S. Patent Publication No. U.S. 2007/0169599 A1. The disclosure in each of these patent documents is incorporated herein by reference.

The drive 26 may be operated by one of: a) a combustible fuel; b) a battery; or c) electrical current from a separately generated supply, such as a household supply that may be connected as through a power cord.

The frame 22 and shaft 28 may have fixed lengths. Alternatively, the frame 22 and shaft 28 may each be made from multiple components that are telescoped, or otherwise moved relative to each other, to effect length adjustment.

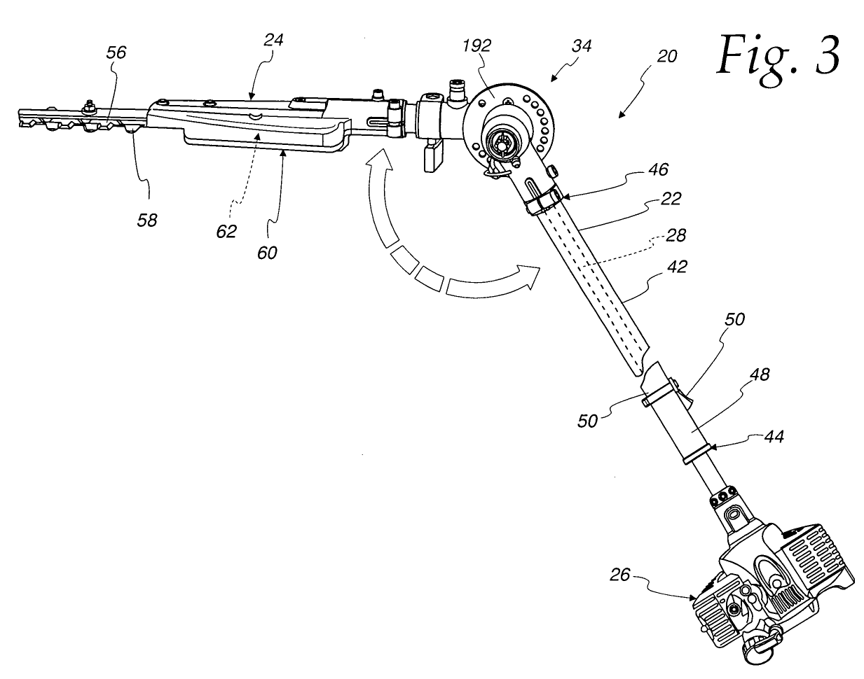

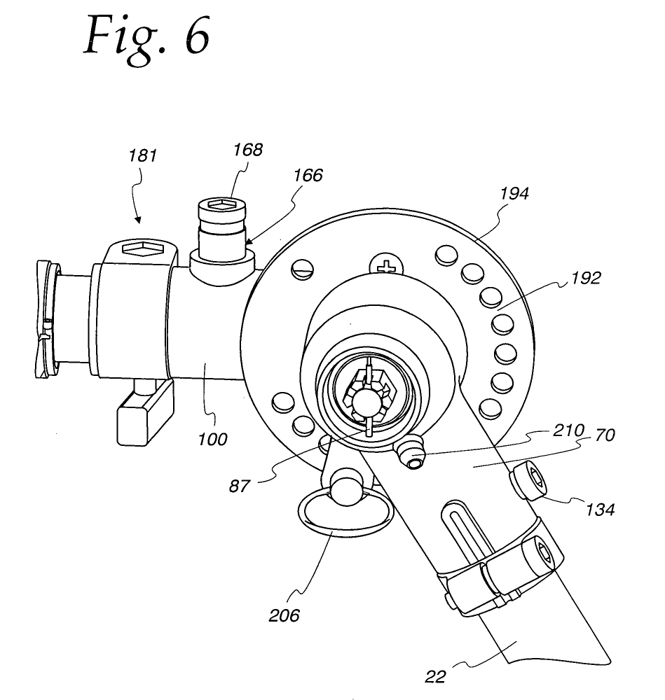

One specific form of the tool 20 will be described hereinbelow with respect to FIGS. 3-12, with it being understood that this form is but exemplary in nature only. The frame 22 on the tool 20 is made from a hollow, tubular element 42, that is substantially straight between proximal and distal ends 44, 46, respectively, of the frame 22.

The drive 26 is provided at the proximal end 44 of the frame 22. In this embodiment, the drive 26 is shown in the form of a two cycle engine. A cushioned grip 48 is also provided at the proximal end 44 of the frame 22 and can be grasped in a manner whereby a user's finger upon the grasping hand can reposition a throttle lever 50 to change the speed of operation for the drive 26.

The shaft 28 extends within a hollow passageway 52 bounded by the tubular element 42. One shaft end (not shown) is coupled to the drive 26 to be turned thereby around the aforementioned first axis 54. The output portion 30 of the shaft 28 has a splined configuration and projects to beyond the distal end 46 of the frame 22.

The working component 24 is shown as a trimmer with reciprocating blades 56, 58. The blades 56, 58 project from a housing 60 which contains drive components 62 that convert rotational movement of the input portion 36 around the aforementioned second axis 64 to a reciprocating action for the blades 56, 58 that cooperate to produce a scissors-like cutting action. The details of the mechanism for, and operation of, the working component 24 are set forth in U.S. Patent Publication 2008/0066325A1, which is incorporated herein by reference. The mechanical and operational details are not critical to the present invention and thus a detailed description thereof will be omitted. It suffices to say that the input portion 36 on the working component 24 has a polygonally-shaped receptacle 66 that can be engaged with a complementarily-shaped shaft 68 that is part of the output portion 38 of the transmission assembly 34, as described in detail hereinbelow.

The transmission assembly 34 has first and second housing parts 70,72 that are movable guidingly relative to each other. A shaft element 74 maintains the first and second housing parts 70, 72 together. More specifically, the shaft element 74 projects through aligned bores 76, 78 in the first and second housing parts 70, 72, respectively. An enlarged head 80 thereon nests flushly in a receptacle 82 in the second housing part 72 with the shaft element 74 fully extended into place. The opposite shaft element end 84 is threaded to accept a securing nut 86. A locking pin 87 extends through the nut 86 and shaft element 74, to prevent inadvertent turning of the nut 86 as might cause loosening thereof in use.

The first housing part 70 has an annular, projecting rim 88 that is concentric with the shaft element 74 and defines a receptacle 90 for the shaft element end 84 and nut 86 thereon. The rim 88 defines a protective shield around the shaft element end 84 and nut 86 to prevent hanging up of the shaft element end 84 and nut 86 upon foliage, or other objects, in use or when the tool 20 is stored.

Each of the housing parts 70, 72 has a similar overall construction. The first housing part 70 has a cup-shaped portion 92 extending around the axis 94 of the shaft element 74. A generally cylindrical connector 96 projects from the cup-shaped portion 92 orthogonally to the axis 94. The housing part 72 has a corresponding cup-shaped portion 98 and a connector 100.

Annular rims 102, 104 on the first and second housing parts 70, 72, respectively, are joined, one within the other. A sealing component 106 is located between the rims 102, 104 to prevent ingress of foreign matter into a gear chamber 108, bounded by the cup-shaped portions 92, 98, and to confine a lubricant therewithin. With this arrangement, the first and second housing parts 70, 72 are guided for movement relative to each other around the axis 94 by the shaft element 74 and the interacting rims 102, 104.

The first housing part 70 contains the input portion 40 for the transmission assembly 34, with the second housing part 72 containing the output portion 38 for the transmission assembly 34.

The input portion 40 consists of a bevel gear 110 with a splined receptacle 112 for the complementarily-splined output portion 30 on the shaft 28. The bevel gear 110 is mounted for guided rotation around the axis 54 by a pair of bearings 114, 116.

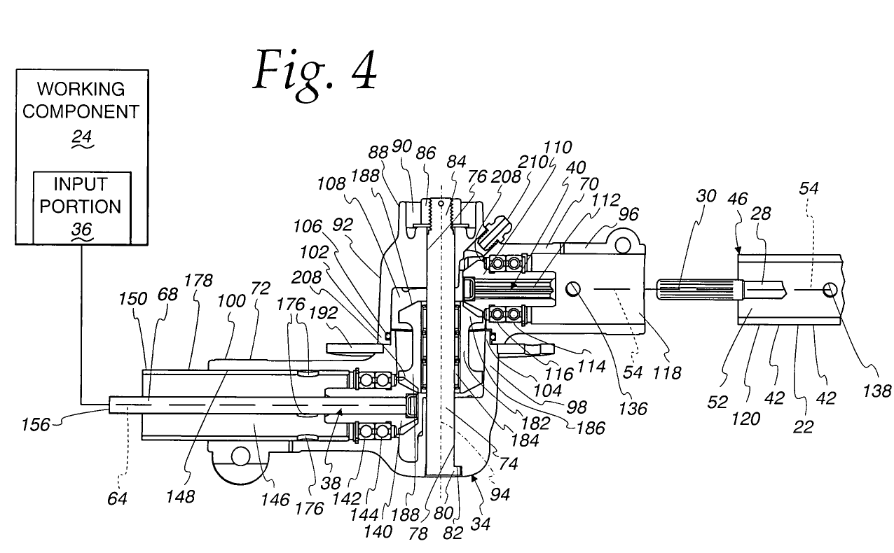

To operatively connect the frame 22 to the transmission assembly 34, the connector 96 and frame 22 are coaxially aligned in spaced relationship, as shown in FIG. 4, with the output portion 30 at the entry to a receptacle 118 defined by the connector 96. By then moving the first housing part 70 and frame 22 axially towards each other, the splined output portion 30 makes a keyed connection with the bevel gear 110 within the receptacle 112. At the same time, the end 120 of the tubular element 42 is extended into, and fits closely within, the receptacle 118. Through a conventional clamping arrangement at 122, built into the connector 96, the connector 96 is fixed relative to the frame 22. More specifically, the clamping arrangement 122 is defined by producing a slot 124 in a connector wall 126. By tightening a bolt 128, portions 130, 132 of the wall 126, on opposite sides of the slot 124, are drawn closer to each other to thereby effectively reduce the diameter of the receptacle 118.

It may be desired to establish and maintain a predetermined angular relationship between the frame 22 and transmission assembly 34. For that purpose, a fastener/bolt 134 may be extended through registrable bores 136, 138 in the connector 96 and frame 22, respectively.

The output portion 38 of the transmission assembly 34 consists of a bevel gear 140 with a construction similar to the bevel gear 110. The bevel gear 140 is fixed to the shaft 68 for rotation therewith around the axis 64. The bevel gear 140 is guided in rotation by a pair of bearings 142, 144 on the housing part 72.

An adapter 146 resides within a receptacle 148 bounded by the connector 100. The adapter 146 is closely received within the receptacle 148 for guided movement around the axis 64 relative to the housing part 72.

The adapter 146 has a portion 150 that projects axially from the connector 100. The extending portion 150 can be directed into a sleeve 152 on the housing 60 on the working component 24. With the extending portion 150 fully seated, the shaft 68 makes a keyed connection within the receptacle 66 of the input portion 36, whereby the shaft 68 and input portion 36 rotate together around the axis 64. The sleeve 152 can be releasably fixed to the extending portion 150 through a clamping arrangement 154 that is similar to the aforementioned clamping arrangement 122.

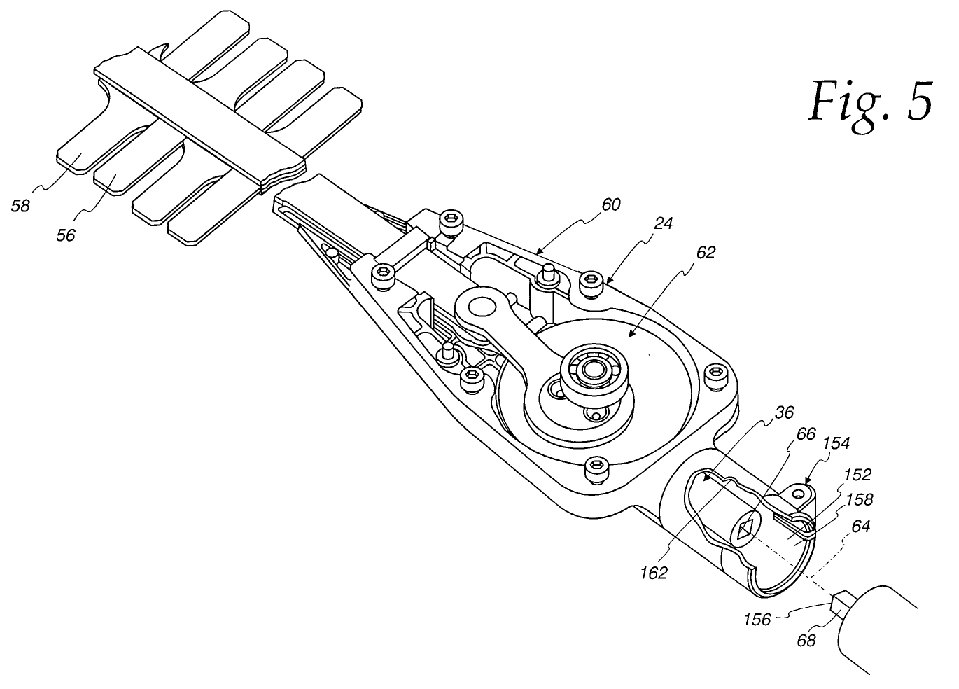

The working component 24 and transmission assembly 34 can be selectively assembled and separated by effecting relative movement in an axial direction towards and away from each other. That is, to effect assembly of the separated working component 24 and transmission assembly 34, the shaft end 156 can be aligned at the entry to a receptacle 158, bounded by the sleeve 152, to be coaxial with the input portion 36, as shown in FIG. 5. By thereafter moving the working component 24 and transmission assembly 34 axially towards each other, the shaft 68 can be directed into the receptacle 66, whereupon the clamping arrangement 154 can be tightened.

To maintain a predictable and predetermined angular relationship between the adapter 146 and working component 24, a fastener/pin/bolt 160 can be directed radially through registrable bores 162,164, respectively in the sleeve 152 and adapter 146.

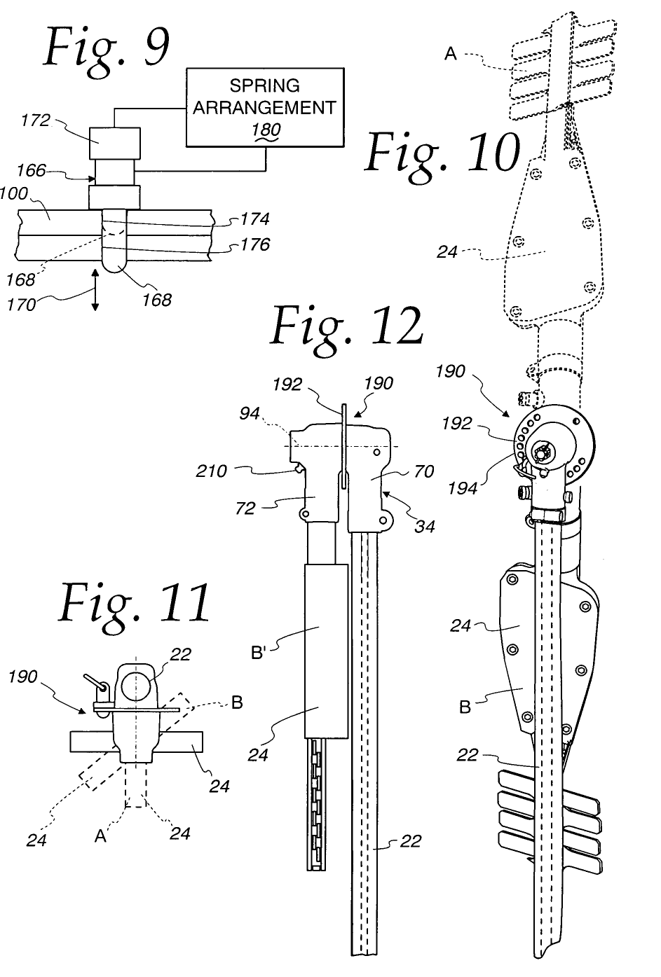

For reasons that will be explained further below, the adapter 146, and the working component 24 attached thereto, may be angularly reoriented relative to the connector 100 around the axis 64 and maintained in any of a plurality of different, selected, angular relationships. To accomplish this, a release pin assembly 166 is provided, as shown in FIG. 9. The release pin assembly 166 consists of a pin 168 that can be extended and retracted radially in the direction of the double-headed arrow 170, as through manipulation of a head 172 thereon. The pin 168 may be normally spring loaded to an extended position, wherein it projects through a bore 174 in the connector 100 and into any of a plurality of angularly spaced, registrable bores 176 (see also FIG. 4) through a wall 178 on the adapter 146. The pin 168 is biased through a spring arrangement 180 radially inwardly to the solid line position in FIG. 9. The head 172 can be manipulated to draw the pin 168 radially outwardly against a force produced by the spring arrangement 180, to the dotted line position in FIG. 9, to thereby allow the working component 24/adapter 146 to be turned relative to the connector 100 around the axis 64 until a desired angular relationship is achieved, whereupon the pin 168 is released to be radially extended into one of the bores 176 aligned therewith.

A clamp arrangement 181 may be provided on the connector 100 to fix the angular relationship between the connector 100 and adapter 146, in place of, or in conjunction with, the fastener/pin 160.

Drive forces are transmitted between the input portion 40 and output portion 38 on the transmission assembly 34 through a two-sided center gear 182, that is guided by the shaft element 74 for movement around the axis 94. A plurality of needle bearings 184 act between the shaft element 74 and center gear 182 to guide movement of the center gear 182 around the shaft element 74 and axis 94.

One gear 186 on the center gear 182 is in mesh with the bevel gear 110, with the other gear 188 in mesh with the bevel gear 140. The gears 186, 186 may be identical, whereby the rotational speed of both bevel gears 110, 140 is the same. This, however, is not a requirement.

With the tool 20 assembled, the axes 54, 64 reside in substantially parallel planes. This, while a preferred arrangement, is not required. By relatively turning the housing parts 70, 72 around the axis 94, the angular relationship between the axis 54 for the frame 22 and axis 64 for the working component 24 can be selectively varied. The configuration shown allows repositioning of the working component 24 through a 360° range around the axes 54, 64, 94.

As shown in FIG. 10, the working component 24 may be repositioned around the axis 94 between one extended operating position, as shown in dotted lines at A in that Figure, and one stored position, as shown in solid lines at B. The working component 24 may be repositioned to any location between the A and B positions.

To maintain different angular relationships between the frame 22 and working component 24 around the axis 94, a locking assembly is provided at 190. The locking assembly 190 consists of cooperating components, one of which is on the housing part 72 in the form of a plate 192, with a rim 194 extending fully around the axis 94. The rim 194 has a series of circumferentially spaced apertures 196, spaced around the axis 94 at a constant diameter. The apertures 196 are selectively registrable with an aperture 198 through a tab 200 on the first housing part 70. The other of the cooperating components on the locking assembly 190 consists of a pin 202 that is extendible through the aligned apertures 196, 198 to releasably maintain a desired angular relationship between the working component 24 and frame 22.

The pin 202 may have any conventional construction that lends itself to being extended into, and retracted from, the aligned apertures 196, 198 while at the same time positively remaining in place without fear of inadvertent repositioning. The pin 202 may have a spring-loaded construction, as for the pin 168, previously described. Alternatively, the pin 202 may have a separate fastening element 204. In the depicted embodiment, the pin 202 has a ring 206 that can be conveniently grasped to hold and manipulate the pin 202.

By reason of having the ability to angularly reorient the working component 24 relative to both the first housing part 70 and the second housing part 72; and the first and second housing parts 70, 72 relative to each other, a plurality of different tool configurations are made possible. Aside from the potentially 360° of relative movement between the housing parts 70, 72, as shown in FIG. 10, the working component 24 can likewise be turned potentially through 360° relative to the second housing part 72, as shown in FIG. 11. As an example, as shown in FIG. 11, the working component 24 may be turned around the axis 64 to the solid line position, or 90° therefrom as shown in dotted lines at A, and in positions therebetween, as shown for the exemplary position in dotted lines at B. This same angular reorientation may be accomplished by turning the transmission assembly 34 around the axis 54.

This feature permits reconfiguration to a stored state different than that shown in FIG. 10. For example, as shown in FIG. 12, the working component 24 may be turned 180°, from the B position in FIG. 10, to be folded against the frame 22 to a stored position as shown at B1 in FIG. 12. Stored states, with the working component between the B and B′ positions are also contemplated.

The transmission assembly 34 is designed as a self-contained unit that can be separated from each of the working component 24 and the frame 22. By providing seals 208 at the bevel gears 110, 140, the housing parts 70, 72 define a sealed gear box. Lubricant can be introduced into, and replenished in, the sealed chamber 108, as through conventional lubrication fittings 210. This construction permits retrofitting of a fixed configuration tool with the transmission assembly 34 to allow incorporation of the adjusting features that make the resulting tool 22 more versatile and at the same time compactable conveniently to any of a number of different stored states.

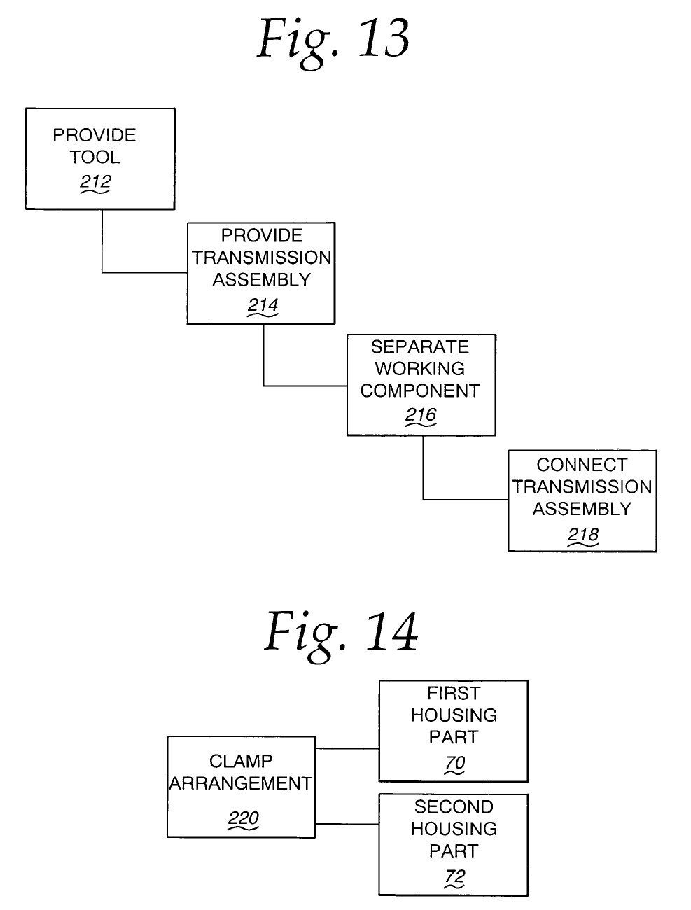

More particularly, the invention is further directed to a method of reconfiguring a portable powered tool, as shown in flow diagram form in FIG. 13.

As shown at block 212, a portable powered tool is provided consisting of: a) a frame; b) a working component on the frame for performing an operation; c) a drive on the frame for operating the working component; and d) a shaft having an output portion that is driven by the drive around a first axis to thereby drive an input portion on the working component around a first axis, thereby to cause operation of the working component.

As shown at block 214, a transmission assembly is provided with an input portion that is movable around one axis and an output portion that is caused by movement of the input portion of the transmission assembly around the one axis to move around another axis. The another axis has an angular relationship with the one axis that can be changed by reconfiguring the transmission assembly.

As shown at block 216, the working component is separated from the shaft.

As shown at block 218, the transmission assembly is operatively connected to the working component and frame so that: a) the output portion on the frame is operatively engaged with the input portion of the transmission assembly; and b) the output portion of the transmission assembly is operatively engaged with the input portion on the working component so that a drive force from the drive is transmitted through the transmission assembly to the working component, for operation thereof.

As noted previously, many variations from the structure, described above, are contemplated. As one example, while each of the housing parts 70, 72 is movable relative to the shaft element 74 around the axis 94, it is possible that one of the housing parts 70, 72 may be fixed relative to the shaft element 74.

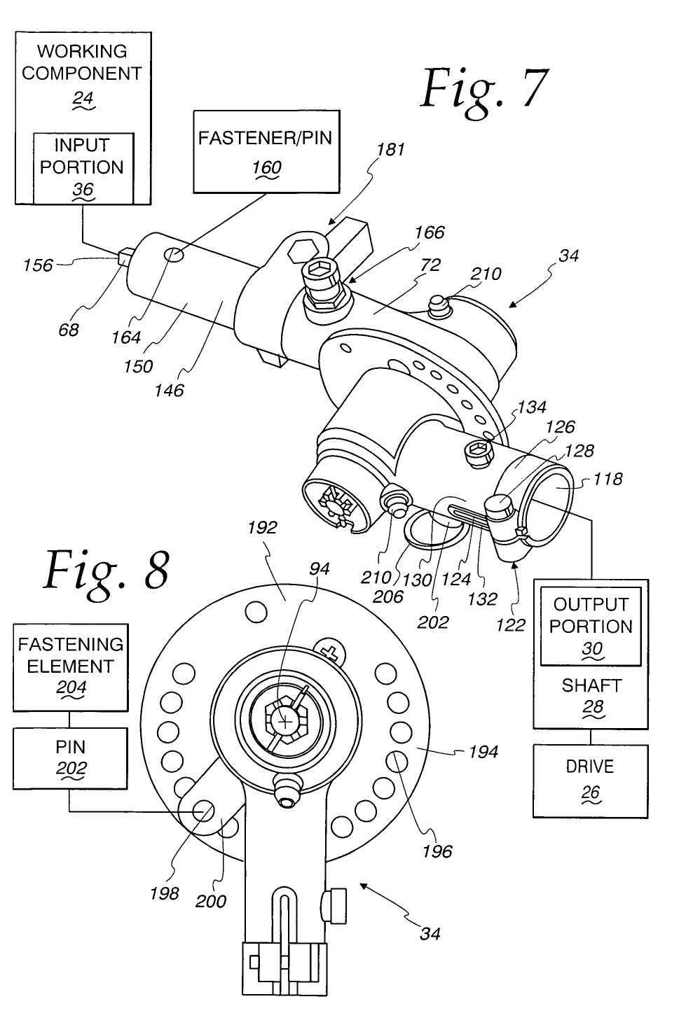

As an alternative to using the cooperating pin 202 and plate 192, as shown in FIG. 8, a clamp arrangement 220, as shown in FIG. 13, having any conventional design, may be used to releasably maintain the first and second housing parts 70, 72 in different, selected, angular relationships.

Similarly, the connection between the first housing part 70 and frame 22, and that between the working component 24 and second housing part 72, may be such as to be maintainable in any angular relationship with any type of structure utilizing clamps or other repositionable elements. Clamping arrangements permit a universal adjusting capability.

The foregoing disclosure of specific embodiments is intended to be illustrative of the broad concepts comprehended by the invention.

1. A portable powered tool comprising:
a frame;
a working component on the frame for performing an operation;
a drive on the frame for operating the working component;
a shaft having a first output portion that is driven by the drive around a first axis to thereby cause operation of the working component; and
a transmission assembly operatively connected to the first output portion of the shaft to transmit a drive force from the first output portion to the working component to thereby cause operation of the working component,
the transmission assembly comprising a second output portion that is driven around a second axis by the drive through the first output portion,
the transmission assembly configured to allow an angular relationship between the first and second axes to be selectively varied.

2. The portable powered tool according to claim 1 wherein the transmission assembly comprises first and second housing parts that are movable guidingly relative to each other around a third axis to thereby change the angular relationship between the first and second axes, the first housing part having a first connection that attaches to the frame, the second housing part operatively connected to the working component.

3. The portable powered tool according to claim 2 wherein the transmission assembly comprises a shaft element that connects to the first and second housing parts and at least one of the first and second housing parts is guided by the shaft element around the third axis relative to the other of the first and second housing parts to thereby change the angular relationship between the first and second axes.

4. The portable powered tool according to claim 2 wherein the second housing part has a second connector that attaches to the working component.

5. The portable powered tool according to claim 4 wherein at least one of: a) the first connector is movable around the first axis relative to the frame to thereby change an angular orientation of the transmission assembly relative to the frame; and b) the second connector is movable around the second axis relative to the working component to thereby change an angular orientation of the transmission assembly relative to the working component.

6. The portable powered tool according to claim 5 wherein at least one of: a) the first connector can be fixed relative to the frame with the transmission assembly in different angular orientations relative to the frame; and b) the second connector can be fixed relative to the working component with the transmission assembly in different angular orientations relative to the working component.

7. The portable powered tool according to claim 3 wherein the transmission assembly comprises a two-sided center gear that is guided by the shaft element in movement around the third axis, the center gear transmitting a drive force from the first output portion to the second output portion.

8. The portable powered tool according to claim 7 wherein the two-sided center gear comprises a first gear and the first output portion has a first bevel gear that is in mesh with the first gear on the center gear.

9. The portable powered tool according to claim 8 wherein the two-sided center gear comprises a second gear and the working component has a second bevel gear that is in mesh with the second gear on the center gear at the second output portion of the transmission assembly.

10. The portable powered tool according to claim 1 wherein the transmission assembly is a self-contained unit that can be separated from each of the working component and the frame.

11. The portable powered tool according to claim 3 wherein the tool further comprises a locking assembly comprising a first locking component on the first housing part and a second locking component on the second housing part, the first and second locking components configured to allow the first and second housing parts to be releasably maintained in a plurality of different relative portions corresponding to different angular relationships between the first and second axes.

12. The portable powered tool according to claim 11 wherein one of the first and second locking components comprises a pin and the other of the first and second locking component comprises at least one member with a plurality of apertures to receive the pin with the first and second housing parts in different relative positions.

13. The portable powered tool according to claim 5 wherein there are components cooperating between at least one of: a) the first connector and frame; and b) the second connector and working component to allow selection of a predetermined angular orientation between the at least one of: a) the first connector and frame; and b) the second connector and working component.

14. The portable powered tool according to claim 13 wherein there is a clamp mechanism for releasably maintaining a predetermined angular orientation between the at least one of: a) the first connector and frame; and b) the second connector and working component.

15. The portable powered tool according to claim 1 wherein the frame comprises a tubular element with an elongate shape having a length extending along the first axis and the shaft resides within the tubular element.

16. The portable powered tool according to claim 1 wherein the working component comprises one of: a) a flexible line trimmer; b) a cutter with a cutting chain that moves in an endless path; and c) a cutter with at least one movable cutting blade.

17. A method of reconfiguring a portable powered tool, the method comprising the steps of:
providing a portable powered tool comprising: a) a frame; b) a working component on the frame for performing an operation; c) a drive on the frame for operating the working component; and d) a shaft having an output portion that is driven by the drive around a first axis to thereby drive an input portion on the working component around a second axis to thereby cause operation of the working component;
providing a transmission assembly with an input portion that is movable around one axis and an output portion that is caused by movement of the input portion of the transmission assembly around the one axis to move around another axis, the another axis having an angular relationship with the one axis that can be changed by reconfiguring the transmission assembly;
separating the working component from the frame; and
operatively connecting the transmission assembly to the working component and frame so that: a) the output portion on the frame is operatively engaged with the input portion of the transmission assembly; and b) the output portion of the transmission assembly is operatively engaged with the input portion of the working component so that a force from the drive is transmitted through the transmission assembly to the working component for operation thereof.

18. The method of reconfiguring a portable powered tool according to claim 17 wherein the step of operatively connecting the transmission comprises relatively moving the transmission assembly and frame along the first axis to thereby operatively engage the output portion on the frame with the input portion on the transmission assembly.

19. The portable powered tool according to claim 17 further comprising the step of relatively repositioning the working component and transmission assembly around the another axis.

20. The portable powered tool according to claim 17 further comprising the step of selectively fixing the angular relationship of the one and another axes in any of a plurality of different angular relationships.
